(19) United States
(12) Patent Application Publication
(10) Pub. No.: US 2024/0297713 A1
(43) Pub. Date: Sep. 5, 2024

(54) RECIPROCITY BASED OPTICAL WIRELESS COMMUNICATION

(71) Applicant: Telefonaktiebolaget LM Ericsson (publ), Stockholm (SE)

(72) Inventors: Rafael PUERTA, SUNDBYBERG (SE); Athanasios STAVRIDIS, MALMÖ (SE); Per-Erik ERIKSSON, STOCKHOLM (SE); Ahmet Burak OZYURT, Edinburgh (GB)

(73) Assignee: Telefonaktiebolaget LM Ericsson (publ), Stockholm (SE)

(21) Appl. No.: 18/571,604

(22) PCT Filed: Oct. 8, 2021
(86) PCT No.: PCT/EP2021/077922

§ 371 Date: Dec. 18, 2023

(30) Foreign Application Priority Data
Jun. 18, 2021 (TR) 2021/009976

(51) Int. Cl. H04B 10/116; H04B 10/50; H04B 10/516

(52) U.S. Cl. CPC H04B 10/116; H04B 10/502; H04B 10/5161

(57) ABSTRACT

A wireless communication device (11, 100) uses at least one light emitting diode (LED) as a transmitter to send outgoing optical wireless communication signals to a further wireless communication device (11, 100). Further, using the at least one LED as a receiver, the wireless communication device (11, 100) receives incoming optical wireless communication signals from the further wireless communication device (11, 100). Based on at least some of the received incoming optical wireless communication signals, the wireless communication device (11, 100) estimates a channel characteristic for the outgoing optical wireless communication signals.

### TECHNICAL FIELD

The present invention relates to methods for controlling optical wireless communication and to corresponding devices, systems, and computer programs.

### BACKGROUND

Optical wireless communication, also denoted as light communication (LC), is expected to have potential to become a new means of indoor wireless communication. Such LC technologies may be based on visible light or infrared light. It is expected that an LC system can achieve a throughput of Gigabits per second. Typically LC technologies are based on communicating binary data using rapidly varying levels of light intensity. For example, one or multiple Light Emitting Diodes (LEDs) are provided in a transmitting device in order to modulate binary data in different levels of emitted light intensity. The levels of the emitted light intensity may be changed at rates that are not perceivable by the human eye. Thus, it is for example possible to incorporate LC in an illumination system, without affecting the quality of illumination. A receiver may detect the changes of the emitted light intensity, e.g., using Photo Detectors (PDs). In this way, the receiver is able to detect the transmitted binary data.

Due to the nature of optical transmitters and receivers, an LC system typically uses Intensity Modulation (IM) with Direct Detection (DD), in the following denoted as IM-DD, see for example “Wireless Infrared Communications” by J. M. Kahn and J. R. Barry, Proc. IEEE, vol. 85, no. 2, pp. 265-298, February 1997. This means that the transmitted/received signal is real and strictly positive, which in turn imposes certain constraints on the deployed communication techniques, both in single-carrier and multi-carrier transmission.

In wireless communication systems, performance can be improved by controlling wireless transmissions taking into account channel characteristics, e.g., in terms of Channel State Information (CSI). However, in existing LC technologies efficient estimation of channel characteristics may be difficult to implement, e.g., due to the rather directive nature of light communication, which causes strong dependency of channel characteristics on relative positioning of transmitter and receiver, and also due to the fact that LC transmitters are typically based on LEDs while receivers are based on PDs, i.e., use IM-DD. Further, the modulation schemes used in existing LC technologies may not allow for recovering both and phase amplitude information from a measured LC signal.

Accordingly, there is a need for techniques which allow for efficiently and accurately estimating channel characteristics of optical wireless communication signals.

### SUMMARY

According to an embodiment, a method of controlling wireless transmissions in a wireless communication network is provided. According to the method, a wireless communication device uses at least one light emitting diode (LED) as a transmitter to send outgoing optical wireless communication signals to a further wireless communication device. Further, using the at least one LED as a receiver, the wireless communication device receives incoming optical wireless communication signals from the further wireless communication device. Based on at least some of the received incoming optical wireless communication signals, the wireless communication device estimates a channel characteristic for the outgoing optical wireless communication signals.

According to a further embodiment, a wireless communication device is provided. The wireless device is configured to, using at least one LED as a transmitter, send outgoing optical wireless communication signals to a further wireless communication device. Further, the wireless device is configured to, using the at least one LED as a receiver, receive incoming optical wireless communication signals from the further wireless communication device. Further, the wireless device is configured to, based on at least some of the received incoming optical wireless communication signals, estimate a channel characteristic for the outgoing optical wireless communication signals.

According to a further embodiment, a wireless communication device is provided. The wireless communication device comprises at least one processor and a memory. The memory contains instructions executable by said at least one processor, whereby the wireless communication device is operative to, using at least one LED as a transmitter, send outgoing optical wireless communication signals to a further wireless communication device. Further, the memory contains instructions executable by said at least one processor, whereby the wireless communication device is operative to, using the at least one LED as a receiver, receive incoming optical wireless communication signals from the further wireless communication device. Further, the memory contains instructions executable by said at least one processor, whereby the wireless communication device is operative to, based on at least some of the received incoming optical wireless communication signals, estimate a channel characteristic for the outgoing optical wireless communication signals.

According to a further embodiment of the invention, a computer program or computer program product is provided, e.g., in the form of a non-transitory storage medium, which comprises program code to be executed by at least one processor of a wireless communication device is provided. Execution of the program code causes the wireless communication device to, using at least one LED as a transmitter, send outgoing optical wireless communication signals to a further wireless communication device. Further, execution of the program code causes the wireless communication device to, using the at least one LED as a receiver, receive incoming optical wireless communication signals from the further wireless communication device.

Further, execution of the program code causes the wireless communication device to, based on at least some of the received incoming optical wireless communication signals, estimate a channel characteristic for the outgoing optical wireless communication signals.

Details of such embodiments and further embodiments will be apparent from the following detailed description of embodiments.

### BRIEF DESCRIPTION OF THE DRAWINGS

FIG. 1 schematically illustrates an example of a scenario where optical wireless communication is controlled according to an embodiment of the invention.

FIG. 2 shows a block diagram for schematically illustrating signal processing in an access node according to an embodiment.

FIG. 3A shows a block diagram for schematically illustrating signal processing in a mobile station according to an embodiment.

FIG. 3B shows a block diagram for schematically illustrating signal processing in a mobile station according to a further embodiment.

FIG. 4 shows an example of a signal constellation of a modulation scheme used according to an embodiment.

FIG. 5 shows a flowchart for schematically illustrating an example of processes according to an embodiment.

FIG. 6 shows a flowchart for schematically illustrating a method according to an embodiment.

FIG. 7 shows a block diagram for schematically illustrating functionalities of a wireless communication device according to an embodiment.

FIG. 8 schematically illustrates structures of a wireless communication device according to an embodiment.

### DETAILED DESCRIPTION OF EMBODIMENTS

In the following, concepts in accordance with exemplary embodiments of the invention will be explained in more detail and with reference to the accompanying drawings. The illustrated embodiments relate to controlling of optical wireless communication (OWC), e.g., based on an LC technology utilizing light in the visible and/or infrared spectrum.

The illustrated concepts involve that a wireless communication device uses at least one LED both as a transmitter for outgoing OWC signals transmitted to a further wireless communication device and as a receiver for incoming wireless communication signals from the further wireless communication device. Estimation of a channel characteristic of the outgoing OWC signals can then be efficiently performed based on at least some of the received incoming OWC signals, assuming channel reciprocity for the incoming and outgoing OWC signals. The assumption of channel reciprocity provides good accuracy for the estimation, because the same LED is used both as transmitter of the outgoing OWC signals and as receiver of the incoming OWC signals, so that transmitter and receiver are co-located and based on the same device type. By utilizing the channel reciprocity, the estimation can also be performed in an efficient manner, without requiring feedback from the further wireless communication device.

Utilization of the LED(s) as a receiver of the incoming optical communication signals may be based on detection of discharging characteristic the LED: While the LED is not transmitting light and is charged in reverse bias, an inherent capacitance discharges at a rate which depends on intensity of light impinging onto the LED. Here, higher intensity of light results in a faster discharging rate. These principles are for example explained in “LED as Transmitter and Receiver of Light: A Simple Tool to Demonstration Photoelectric Effect” by G. Schirripa Spagnolo, F. Leccese, and M. Leccisi, Crystals, vol. 9, no. 10, pp. 1-17 (October 2019). Accordingly, in the illustrated concepts an intensity modulation of the incoming OWC signals can be detected based on the discharging rate of the LED(s). The operation of the LED(s) as both transmitter and receiver may thus be based on intensity-modulation (IM) and direct-detection (DD), in the following referred to as IM-DD operation.

The estimation of the channel characteristic may be based on coherent detection, thereby enabling utilization of both phase information and amplitude information in the estimation process. For this purpose, the OWC signals may be modulated using a real-valued and unipolar modulation scheme, in particular a real-valued and unipolar multi-carrier modulation scheme, such as direct current optical orthogonal frequency division multiplexing (DCO-OFDM). Receiver processing of the OWC signals may then be, and the reception is based on an orthogonal frequency division multiplexing (OFDM) receiver chain similar to conventional OFDM-based radio technologies, e.g., based on discrete Fourier transform (DFT) or fast Fourier transform (FFT) processing of the received OWC signals. Alternatively, the receiver processing could be based on an advanced phase recovery scheme, e.g., using a Kramers-Kronig receiver.

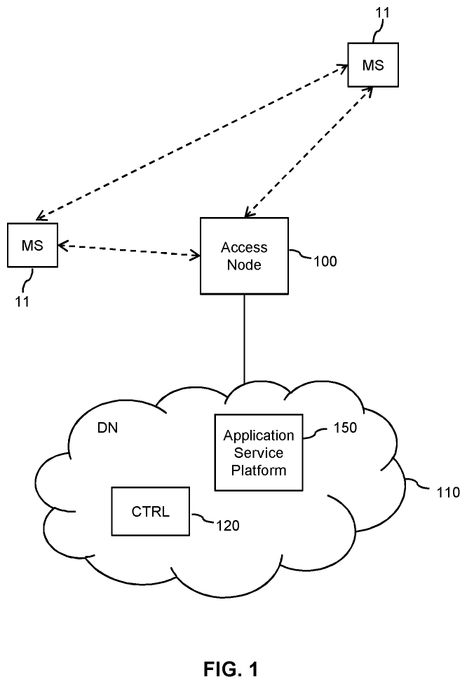

FIG. 1 schematically illustrates an example of a scenario where OWC is controlled in accordance with the illustrated concepts. Specifically, FIG. 1 illustrates a wireless communication network environment which is, at least in part, based on utilization of OWC. It is noted that the wireless communication network could additionally also support one or more other wireless communication technologies, e.g., a Wireless Local Area Network (WLAN) technology and/or a cellular communication technology as for example specified by 3GPP (3^{rd} Generation Partnership Project). In the example of FIG. 1, the wireless communication network includes an access node 100 and a number of mobile stations (MSs) 11. As illustrated by broken arrows, each MS 11 may use OWC signals to connect to the access node 100. Further, it is also possible that two MSs 11 use OWC signals to connect directly to each other. The OWC signals may thus be used to establish one or more OWC links. The OWC may be bi-directional. Accordingly, each MS 11 and the access node 100 may both transmit outgoing OWC signals and receive incoming wireless communication signals. OWC signals transmitted from the access node 100 to one of the MSs 11 may also be referred to as downlink (DL) OWC signals. OWC signals transmitted from one of the MSs 11 to the access node 100 may also be referred to as downlink (UL) OWC signals. OWC signals transmitted between two MSs 11 may also be referred to as device-to-device (D2D) OWC signals.

Based on the DL and UL OWC signals, the access node 100 may provide data connectivity of the MSs 11 among each other and/or with respect to a data network (DN) 110. In this way, the access node 100 may also provide data connectivity of a given MS 11 other entities, e.g., to one or more servers, service providers, data sources, data sinks, user terminals, host computers, or the like. Accordingly, an OWC link established between a given MS 11 and the access node 100 may be used for providing various kinds of data services to the MS 11, e.g., a service related to industrial machine control. Such services may be based on applications which are executed on the MS 11 and/or on a device linked to the MS 11. By way of example, FIG. 1 illustrates an application service platform 150 provided in the DN 110. The application(s) executed on the MS 11 and/or on one or more other devices linked to the MS 11 may use the respective OWC link established by the MS 11 for data communication with one or more other MSs 11 and/or the application service platform 150, thereby enabling utilization of the corresponding service(s) at the MS 11. As further illustrated, the DN 110 includes a control node 120, which may be used for controlling and otherwise coordinating operation of the access node 100 and MSs 11.

It is noted that the wireless communication network may also include additional access nodes in order to enhance wireless coverage of the wireless communication network. Each of such access nodes may operate as explained for the access node 100 to provide data connectivity to one or more connected MSs.

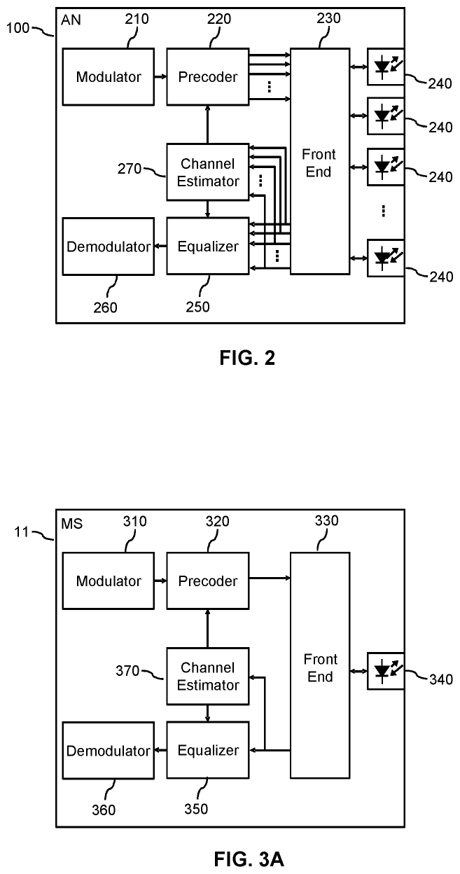

FIG. 2 schematically illustrates an exemplary implementation of the signal processing in the access node 100. As illustrated, the access node 100 is provided with a modulator 210 for performing the real-valued and unipolar modulation of the outgoing OWC signals. Further, the access node 100 is provided with a precoder 220 for performing precoding of the modulated OWC signals, e.g., according to a multiple-input single-output (MISO) scheme or according to a multiple-input multiple-output (MIMO) scheme. Further, the access node 100 is provided with a front end 230 which drives multiple LEDs 240 according to the modulated and precoded OWC signals. The frontend 230 is also responsible for the detection of incoming OWC signals received via the LEDs 240, e.g., based on the discharge rate of the LEDs 240 as explained above. For the incoming OWC signals received via the LEDs 240 and detected by the front end 230, the access node 100 is provided with an equalizer 250 for performing equalization of the received OWC signals and with a demodulator 260 for demodulation of the received OWC signals. Further, the access node 100 is provided with a channel estimator 270 for performing channel estimation based on the received OWC signals. A channel characteristic estimated by the channel estimator 270 is used to control the precoding of the outgoing OWC signals performed by the precoder 220 and the equalization of the received OWC signals performed by the equalizer 250.

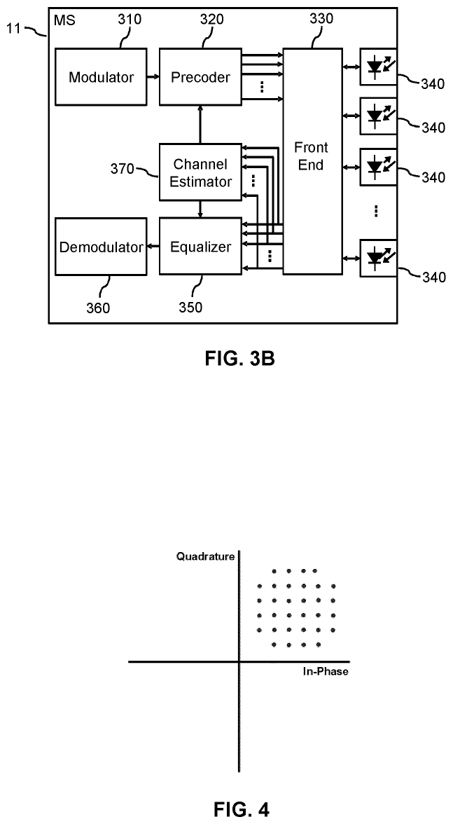

FIG. 3A schematically illustrates an exemplary implementation of the signal processing in the MS 11. As illustrated, the MS 11 is provided with a modulator 310 for performing the real-valued and unipolar modulation of the outgoing OWC signals. Further, the MS 11 is provided with a precoder 320 for performing precoding of the modulated OWC signals, e.g., according to a MISO scheme. Further, the MS 11 is provided with a front end 330 which drives a single LED 340 according to the modulated and precoded OWC signals. The front end 330 is also responsible for the detection of incoming OWC signals received via the LED 340, e.g., based on the discharge rate of the LED 340 as explained above. For the incoming OWC signals received via the LED 340 and detected by the front end 330, the MS 11 is provided with an equalizer 350 for performing equalization of the received OWC signals and with a demodulator 360 for demodulation of the received OWC signals. Further, the MS 11 is provided with a channel estimator 370 for performing channel estimation based on the received OWC signals. A channel characteristic estimated by the channel estimator 370 is used to control the precoding of the outgoing OWC signals performed by the precoder 320 and the equalization of the received OWC signals performed by the equalizer 350.

FIG. 3B schematically illustrates an exemplary implementation of the signal processing in the MS 11. As illustrated, the MS 11 is provided with a modulator 310 for performing the real-valued and unipolar modulation of the outgoing OWC signals. Further, the MS 11 is provided with a precoder 320 for performing precoding of the modulated OWC signals, e.g., according to a MIMO scheme. Further, the MS 11 is provided with a front end 330 which drives multiple LEDs 340 according to the modulated and precoded OWC signals. The front end 330 is also responsible for the detection of incoming OWC signals received via the LEDs 340, e.g., based on the discharge rate of the LEDs 340 as explained above. For the incoming OWC signals received via the LEDs 340 and detected by the front end 330, the MS 11 is provided with an equalizer 350 for performing equalization of the received OWC signals and with a demodulator 360 for demodulation of the received OWC signals. Further, the MS 11 is provided with a channel estimator 370 for performing channel estimation based on the received OWC signals. A channel characteristic estimated by the channel estimator 370 is used to control the precoding of the outgoing OWC signals performed by the precoder 320 and the equalization of the received OWC signals performed by the equalizer 350.

In a single user MISO (SU-MISO) scheme, the signal processing in the access node 100 as illustrated in FIG. 2 may cooperate with the signal processing in the MS 11 as illustrated in FIG. 3A, noting that the outgoing OWC signals transmitted from the access node 100 correspond to the incoming OWC signals received by the MS 11 and the outgoing OWC signals transmitted from the MS 11 correspond to the incoming OWC signals received by the access node 100. In a single user MIMO (SU-MIMO) scheme, the signal processing in the access node 100 as illustrated in FIG. 2 may cooperate with the signal processing in the MS 11 as illustrated in FIG. 3B, noting that the outgoing OWC signals transmitted from the access node 100 correspond to the incoming OWC signals received by the MS 11 and the outgoing OWC signals transmitted from the MS 11 correspond to the incoming OWC signals received by the access node 100. Multi-user MISO (MU-MISO) or multi-user MIMO schemes could be supported as well, by assigning subsets of the channels from the access node 100 formed by the pre-coding to different MSs 11. The applicability, and typically also the system design or setup, of MU-MISO or MU-MIMO may depend on the channel conditions, e.g., may require that the estimated channel rank is larger than one.

Due to the nature of the IM-DD operation of the LEDs 240, 340, each acting both as transmitter and receiver, conventional modulation and receiving schemes would not allow for utilizing both phase and amplitude information in the channel estimation and, consequently, in the pre-coding and equalization at processing blocks 220, 250, 320, 350. As indicated above, in the illustrated concepts this aspect may be addressed by utilization of a suitable designed modulation scheme.

Conventional multicarrier modulation schemes, such as OFDM, may facilitate estimation of channel characteristics, e.g., using pilot-based channel estimation schemes. The output of such conventional multicarrier modulation schemes is typically a complex signal, having both phase and amplitude and phase information. As compared to that, the illustrated concepts involve intensity modulation of electrical signals driving the LED(s) 240, 340, using real-valued positive valued signals. Accordingly, the electrical signal used to modulate the instantaneous drive power of the LED is real-valued and unipolar, in particular positive-valued. In the illustrated concepts a OFDM scheme producing complex valued modulation signals may thus be modified to convert the modulation signals into real-valued and unipolar signals for driving the LEDs. For example, this may be accomplished by using DC biased optical OFDM (DCO-OFDM) or asymmetrically clipped optical OFDM (ACO-OFDM).

Similar to photodetectors, operation of the LEDs to detect the OWC signals is based on a square-law characteristic, i.e., the output signal of the LED is proportional to the input optical field power. Due to this square-law characteristic, phase information of the transmitted signal would normally be lost after photodetection.

However, to estimate the channel characteristic recovering both amplitude and phase information is preferable, which may be accomplished by coherent detection of the OWC signal. To enable retrieval of the phase of the transmitted OWC signal, the data may be electrically pre-modulated on one or more subcarriers using a subcarrier modulation (SCM) technique before modulating the LED optical carrier. The SCM technique allows the amplitude and phase information of each subcarrier to be retrieved after direct detection by the LED, since each subcarrier beats with the transmitting LED's optical carrier within the receive bandwidth (BW) of the LED. This may be regarded as a form of heterodyne detection. Given an optical carrier signal r_{c}(t)=|A|e^{i(2πf}^{_{c}}^{t)} and a transmitted signal rₛ(t)=|E(t)|e^{i(2πf}^{ₛ}^{+φ}^{ₛ}⁾ at a subcarrier frequency fₛ, the resulting signal after photodetection may be expressed as:

$${\vert {r}_{c} ( t ) + {r}_{s} ( t ) \vert}^{2} = {\vert E ( t ) \vert}^{2} + {\vert A \vert}^{2} + 2 \vert E ( t ) \vert \vert A \vert cos ( 2 π {f}_{s} t + {φ}_{s} ( t ) ) \qquad ( 1 )$$

Here it should be noted that the amplitude |A| of the optical carrier amplitude may be regarded as an amplification factor. Thus by using an adequate optical carrier power and a direct current (DC) blocker, the signal-to-signal beating products (SSBP), i.e., the term |E(t)|² term due to the square-law of the photoreceiver and the DC term |A|² are negligible. Therefore, after direct detection of the OWC signal, it is possible to retrieve the transmitted signal phase φₛ(t) and restore the signal complex amplitude E(t) through digital signal processing (DSP) of the heterodyne-detected signal.

Thus, after photodetection, if a real-valued unipolar multicarrier modulation scheme is used at the transmitting wireless communication device, the receiving wireless communication device can estimate the channel characteristic using an OFDM receiver chain based on a DFT or FFT algorithm.

According to a further option, both phase and amplitude information of the received OWC signal can be recovered using advanced receiver processing, such as by a Kramers-Kronig (KK) receiver. This can be done for both single carrier and multicarrier modulation schemes.

As further explained in “Kramers-Kronig coherent receiver” by A. Mecozzi et. al., Optica 3, 1218-1227, (2016) the KK relations may allow to determine the phase of the optical field entirely from its intensity. The KK relations are described by:

$$h ( t ) = \sqrt[2]{s ( t )} \qquad ( 2 )$$

$${φ}_{s} ( t ) = {F}^{- 1} \{ i sign ( ω ) F \{ ln [ \vert h ( t ) \vert ] \} \} \qquad ( 3 )$$

$${s}_{KK} ( t ) = h ( t ) {e}^{i {φ}_{s} ( t )} , \qquad ( 4 )$$

where s(t) is the double sideband (DSB) real-valued signal obtained after photodetection, φₛ(t) is its phase, sign(ω) is the sign function, which is equal to 1 for ω>0, to 0 for ω=0, and to −1 for ω<0, and F{ } and F⁻¹{ } denote the Fourier and inverse Fourier transform respectively.

To maximize the spectral efficiency (SE) of a system using the KK receiver scheme, typically a single sideband (SSB) signal is transmitted, however since LEDs are IM devices only double sideband signals (DSB) can be transmitted. The KK receiver processing is the same for DSB signals. Additionally, to ensure the optimal performance of KK receivers when transmitting DSB signals, the transmitted OWC signals should be strictly positive. FIG. 4 illustrates an example of a corresponding signal constellation. More specifically, FIG. 4 shows an exemplary signal constellation in the complex plane which corresponds to a strictly positive 32 level quadrature amplitude modulation (32-QAM) OWC signal.

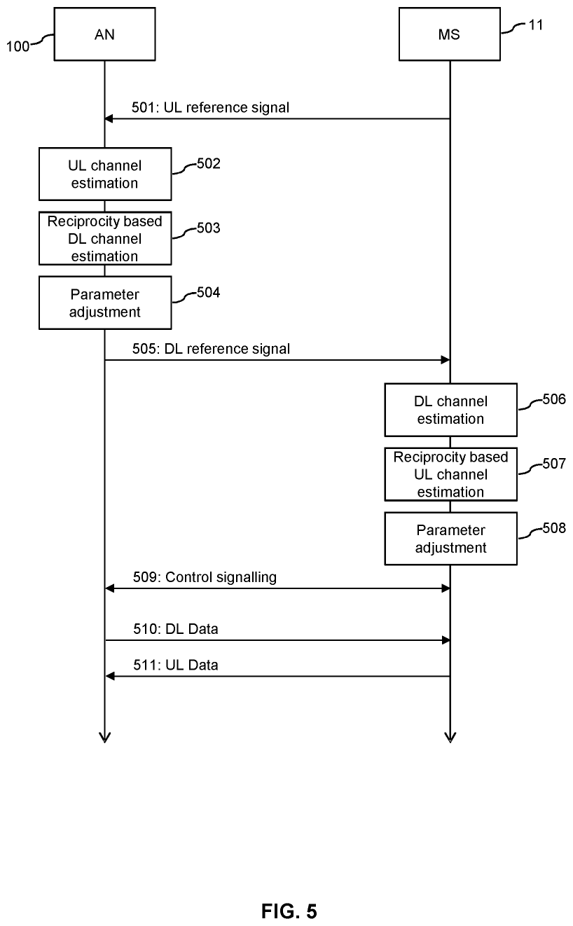

In the illustrated concepts, the reciprocity-based estimation of the channel characteristic may be used for efficiently control the outgoing OWC signals. For example, the access node 100 may estimate the characteristic of the UL channel from the MS 11 based on reference signals (RS) transmitted by the MS 11. Based on the reciprocity assumption, the access node 100 may then estimate the characteristic of the DL channel from the characteristic of the UL channel, i.e., by assuming that the DL characteristic is substantially the same as the UL characteristic. FIG. 5 illustrates an example of processes in which reciprocity-based estimation of channel characteristics is used for controlling OWC based transmission of DL data and UL data between an access node (AN) 100 and an MS 11, which may for example correspond to the access node 100 and one of the MSs 11 illustrated in FIG. 1.

As illustrated, the MS 11 may send a UL reference signal 501, which is received by the access node 100. As illustrated by block 502, the access node 100 then performs UL channel estimation. Specifically, block 502 involves that the access node 100 determines a channel characteristic of the UL channel from the MS 11 to the access node 100 from the received UL reference signal 501. The channel characteristic may for example be determined in terms of CSI. The estimation may for example be based on minimization of Minimum Mean Square Error (MSE) or other known methods of measuring a channel characteristic from a reference signal. The UL channel estimation of block 502 is performed after photodetection by the LEDs 240 and the front end 230. The estimated channel characteristic thus includes both the electro-optic components of the MS 11, the electro-optic components of the access node 100, and the wireless optical channel between the MS 11 and the access node 100. As illustrated by block 503, the access node 100 then performs reciprocity-based DL channel estimation. The reciprocity-based DL channel estimation of block 502 involves assuming that a channel characteristic of the DL channel from the access node 100 is substantially the same as the channel characteristic of the UL channel estimated at block 502. Then, based on the estimated channel characteristic of the DL channel, the access node 100 performs adjustment of processing parameters for OWC signals, as illustrated by block 503. This may in particular involve calculating equalizer weights applied by the equalizer 250. For example, the access node 100 may apply a given metric to the estimated CSI to calculate the equalizer weights. Further, the parameter adjustment also involves calculating precoder weights applied by the precoder 220. The precoder weights may be calculated directly from the weights of the equalizer 250 or may be calculated from the estimated channel characteristic of the DL channel, e.g., using the same metric as used for calculation of the equalizer weights or some other metric. By way of example, a maximum ratio transmission (MRT) scheme could be used to calculate the precoder weights from the estimated channel characteristic. Further, depending on the estimated characteristic of the UL channel the access node 100 may allocate different power to different carriers of the multi-carrier modulation scheme applied by the modulator 210. As a result, the access node 100 may thus adjust phase and/or amplitude of the modulation depending on the estimated characteristic of the DL channel.

At the side of the MS 11, a similar procedure may be used. In particular, the access node 100 may send a DL reference signal 505, which is received by the MS 11. As illustrated by block 506, the MS 11 then performs DL channel estimation. Specifically, block 506 involves that the access node 100 determines a channel characteristic of the DL channel from the access node 100 to the MS 11 from the received DL reference signal 505. The channel characteristic may for example be determined in terms of CSI. The estimation may for example be based on minimization of MSE or other known methods of measuring a channel characteristic from a reference signal. The DL channel estimation of block 506 is performed after photodetection by the LED(s) 340 and the front end 330. The estimated channel characteristic thus includes both the electro-optic components of the access node 100, the electro-optic components of the MS 11, and the wireless optical channel between the access node 100 and the MS 11. As illustrated by block 507, the MS 11 then performs reciprocity-based UL channel estimation. The reciprocity-based UL channel estimation of block 507 involves assuming that a channel characteristic of the UL channel from the MS 11 is substantially the same as the channel characteristic of the DL channel estimated at block 506. Then, based on the estimated channel characteristic of the UL channel, the MS 11 performs adjustment of processing parameters for OWC signals, as illustrated by block 508. This may in particular involve calculating equalizer weights applied by the equalizer 350. For example, the MS 11 may apply a given metric to the estimated CSI to calculate the equalizer weights. Further, the parameter adjustment also involves calculating precoder weights applied by the precoder 320. The precoder weights may be calculated directly from the weights of the equalizer 350 or may be calculated from the estimated channel characteristic of the UL channel, e.g., using the same metric as used for calculation of the equalizer weights or some other metric. By way of example, an MRT scheme could be used to calculate the precoder weights from the estimated channel characteristic.

Further, depending on the estimated characteristic of the UL channel the MS 11 may allocate different power to different carriers of the multi-carrier modulation scheme applied by the modulator 310. As a result, the MS 11 may thus adjust phase and/or amplitude of the modulation depending on the estimated characteristic of the UL channel.

Depending on the level of autonomy of the MS 11, the MS 11 may negotiate parameters of UL OWC signals with the access node 100, e.g., by indicating a suggestion on which subcarriers and/or with which power the UL OWC are intended to be transmitted. Such suggestions may then be confirmed or modified in a response from the access node. In the example of FIG. 5, control signalling 509 could be used for the purpose of negotiating the parameters applied by the MS 11. The control signalling 509 could for example be exchanged on a Medium Access Control (MAC) layer.

As further illustrated, the access node 100 may then use DL OWC signals to send DL data 510 to the MS 11, and the MS 11 may use UL OWC signals to send UL data 511 to the access node. The transmission of the DL data 510 and the UL data 511 may be performed in a half-duplex (HD) mode, so that at a given time either only the DL data 510 or the UL data 511 is transmitted. Various kinds of TDD (time division duplex) schemes may be used to coordinate the transmissions of the DL data 510 or the UL data 511.

It is noted that processes which are similar to that of FIG. 5 could also be applied in direct OWC between two MS 11.

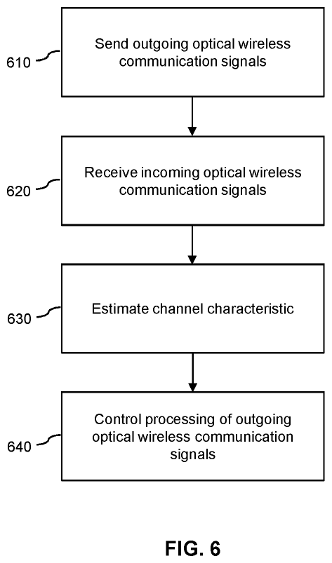

FIG. 6 shows a flowchart for illustrating a method, which may be utilized for implementing the illustrated concepts. The method of FIG. 6 may be used for implementing the illustrated concepts in a wireless communication device, such as the above-mentioned access node 100 or one of the above-mentioned MSs 11.

If a processor-based implementation of the wireless communication device is used, at least some of the steps of the method of FIG. 6 may be performed and/or controlled by one or more processors of the wireless device. Such wireless device may also include a memory storing program code for implementing at least some of the below described functionalities or steps of the method of FIG. 6.

At step 610, the wireless communication device sends outgoing OWC signals to a further wireless communication device. For sending the outgoing OWC signals, the wireless communication device uses at least one LED as a transmitter. The outgoing OWC signals may be modulated based on a multicarrier modulation scheme. Further, the outgoing OWC signals may be modulated on a real-valued unipolar modulation scheme In particular, the outgoing OWC signals may be modulated based on a real-valued unipolar multicarrier modulation scheme. The wireless communication device can be a mobile station, such as one of the above-mentioned MSs 11. The further wireless communication device can be an access node of a wireless communication network, such as the above-mentioned access node 100, or a further mobile station, such as one of the above-mentioned MSs 11. In other scenarios, the wireless communication device could be an access node of a wireless communication network, such as the above-mentioned access node 100, and the further wireless communication device could be a mobile station, such as one of the above-mentioned MSs 11.

At step 620, the wireless communication device receives incoming OWC signals from the further wireless communication device. For receiving the incoming OWC signals, the wireless communication device uses the at least one LED as a receiver. The incoming OWC signals may be modulated based on a multicarrier modulation scheme. Further, the incoming OWC signals may be modulated on a real-valued unipolar modulation scheme In particular, the incoming OWC signals may be modulated based on a real-valued unipolar multicarrier modulation scheme. The modulation scheme used for the incoming OWC signals may be the same as the modulation scheme used for the outgoing OWC signals.

At step 630, the wireless communication device estimates a channel characteristic for the outgoing OWC signals. This estimation is performed based on at least some of the received incoming OWC signals. In some scenarios, the incoming OWC signals include reference signals, such as the UL reference signal 501 or the DL reference signal 505 in the example of FIG. 5. The wireless communication device may then estimate the channel characteristic based on the reference signals.

Step 630 may involve that the wireless communication device estimates the channel characteristic based on coherent detection of phase and amplitude of the incoming optical wireless communication signals. This may for example be accomplished based on DFT processing of the incoming optical wireless communication signals, e.g., as explained in connection with relation (1), or based on Kramers-Kronig receiver processing of the incoming optical wireless communication signals, e.g., as explained in connection with relations (2), (3), and (4).

At step 640, the wireless communication device may control processing of the outgoing OWC signals based on the channel characteristic estimated at step 630. This may involve that, based on the estimated channel characteristic, the wireless communication device adjusts amplitude and/or phase of the modulated outgoing OWC signals. Further, based on the estimated channel characteristic, the wireless communication device may calculate precoding weights of the outgoing optical wireless communication signals.

Further, step 640 may involve that the wireless communication device adapts the outgoing optical wireless communication signals based on the estimated channel characteristic and control signalling between the wireless communication device and the further wireless communication device, such as the control signalling 509 in the example of FIG. 5.

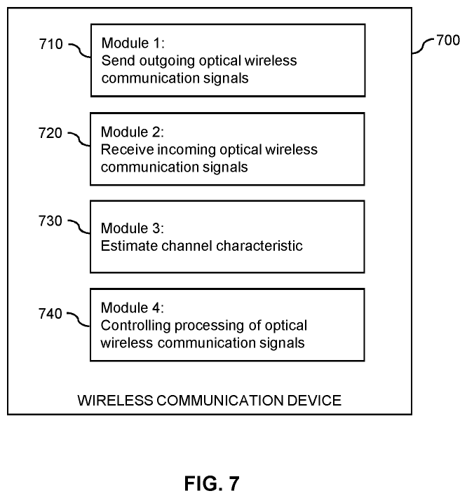

FIG. 7 shows a block diagram for illustrating functionalities of a wireless communication device 700 which operates according to the method of FIG. 6. The wireless communication device 700 may for example correspond to the above-mentioned access node 100 or one of the above-mentioned MSs 11. As illustrated, the wireless communication device 700 may be provided with a module 710 configured to send outgoing OWC signals, such as explained in connection with step 610. Further, the wireless communication device 700 may be provided with a module 720 configured to receive incoming OWC signals, such as explained in connection with step 620. Further, the wireless communication device 700 may be provided with a module 730 configured to estimate a channel characteristic, such as explained in connection with step 630. Further, the wireless communication device 700 may be provided with a module 740 configured to estimate parameters, such as explained in connection with step 640.

It is noted that the wireless communication device 700 may include further modules for implementing other functionalities, such as known functionalities of a mobile station or of an access node of a wireless communication network. Further, it is noted that the modules of the wireless communication device 700 do not necessarily represent a hardware structure of the wireless communication device 700, but may also correspond to functional elements, e.g., implemented by hardware, software, or a combination thereof.

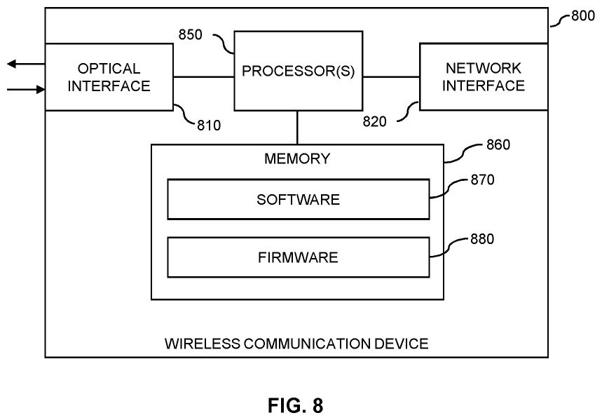

FIG. 8 illustrates a processor-based implementation of a wireless communication device 800. The structures as illustrated in FIG. 8 may be used for implementing the above-described concepts. The wireless communication device 800 may for example correspond to one of above-mentioned mentioned MSs 11 or to the above-mentioned access node 100.

As illustrated, the wireless communication device 800 includes an optical interface 810. The optical interface may for example be based on an LC technology, e.g., operating in the visible and/or infrared spectrum. Further, if the wireless communication device 800 corresponds to an access node, such as the above-mentioned access node 100, the wireless communication device 800 may also include a network interface 820, which may be used for communication with other nodes of the wireless communication network.

Further, the wireless communication device 800 includes one or more processors 850 coupled to the interface(s) 810, 820 and a memory 860 coupled to the processor(s) 850. By way of example, the interface(s) 810, 820, the processor(s) 850, and the memory 860 could be coupled by one or more internal bus systems of the wireless communication device 800. The memory 860 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 860 may include software 870 and/or firmware 880. The memory 860 may include suitably configured program code to be executed by the processor(s) 850 so as to implement the above-described functionalities for controlling wireless transmissions, such as explained in connection with FIG. 6.

It is to be understood that the structures as illustrated in FIG. 8 are merely schematic and that the wireless communication device 800 may actually include further components which, for the sake of clarity, have not been illustrated, e.g., further interfaces or further processors. Also, it is to be understood that the memory 860 may include further program code for implementing known functionalities of a mobile station or access node. According to some embodiments, also a computer program may be provided for implementing functionalities of the wireless communication device 800, e.g., in the form of a physical medium storing the program code and/or other data to be stored in the memory 860 or by making the program code available for download or by streaming.

As can be seen, the concepts as described above may be used for efficiently controlling OWC. By using one or more LEDs that operate both as transmitter and receiver, the transmitting and receiving optical interface of the wireless communication device are co-located, which allows for applying a reciprocity assumption for the incoming and outgoing OWC signals. Based on the estimated channel characteristic, optical wireless MISO and MIMO schemes can be implemented in an efficient manner thereby improving throughput and spectral usage. Further, use of LEDs for light reception allows for efficiently reusing part of the transmitting circuitry and the transmitting optical front end without requiring additional dedicated hardware, e.g. reception PDs. Thus, cost reduction is possible. The smaller number of required components may facilitate realization of small-form factor and/or low power wireless communication devices, e.g., for in Internet of Things (IoT) deployments, which are often subject to power and/or space constraints.

It is to be understood that the examples and embodiments as explained above are merely illustrative and susceptible to various modifications. For example, the illustrated concepts may be applied in connection with various kinds of OWC technologies. Further, the concepts May be applied with respect to various types of wireless communication devices. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1. A method of controlling optical wireless communication, the method comprising:
using at least one light emitting diode, LED, as a transmitter, a wireless communication device sending outgoing optical wireless communication signals to a further wireless communication device;
using the at least one LED as a receiver, the wireless communication device receiving incoming optical wireless communication signals from the further wireless communication device; and
based on at least some of the received incoming optical wireless communication signals, the wireless communication device estimating a channel characteristic for the outgoing optical wireless communication signals.

2. The method according to claim 1, wherein the outgoing optical wireless communication signals and the incoming optical wireless communication signals are modulated based on a multicarrier modulation scheme.

3. The method according to claim 1, wherein the outgoing optical wireless communication signals and the incoming optical wireless communication signals are modulated based on a real-valued unipolar modulation scheme.

4. The method according to claim 3, wherein the wireless communication device estimates the channel characteristic based on coherent detection of phase and amplitude of the incoming optical wireless communication signals.

5. The method according to claim 4, wherein the wireless communication device estimates the phase and the amplitude based on discrete Fourier transform, DFT, processing of the incoming optical wireless communication signals.

6. The method according to claim 4, wherein the wireless communication device estimates the phase and the amplitude based on Kramers-Kronig, KK, receiver processing of the incoming optical wireless communication signals.

7. The method according to claim 2, comprising:
based on the estimated channel characteristic, the wireless communication device adjusting amplitude and/or phase of the modulated outgoing optical wireless communication signals.

8. The method according to claim 1, comprising:
based on the estimated channel characteristic, the wireless communication device calculating precoding weights of the outgoing optical wireless communication signals.

9. The method according to claim 1, comprising:
the wireless communication device adapting the outgoing optical wireless communication signals based on the estimated channel characteristic and control signalling between the wireless communication device and the further wireless communication device.

10. The method according to claim 1,
wherein the incoming optical communication signals include reference signals, and
wherein the wireless communication device estimates the channel characteristic based on the reference signals.

11. The method according to claim 1, wherein the wireless communication device is a mobile station.

12. The method according to claim 1, wherein the further wireless communication device is an access node of a wireless communication network.

13. The method according to claim 1, wherein the wireless communication device is an access node of a wireless communication network.

14. The method according to claim 1, wherein the further wireless communication device is a mobile station.

15. A wireless communication device, the wireless communication device being configured to:
using at least one light emitting diode, LED, as a transmitter, send outgoing optical wireless communication signals to a further wireless communication device;
using the at least one LED as a receiver, receive incoming optical wireless communication signals from the further wireless communication device; and
based on at least some of the received incoming optical wireless communication signals, estimate a channel characteristic for the outgoing optical wireless communication signals.

16. The wireless communication device according to claim 15, wherein the outgoing optical wireless communication signals and the incoming optical wireless communication signals are modulated based on a multicarrier modulation scheme.

17. The wireless communication device according to claim 15, comprising:
at least one processor, and
a memory containing program code executable by the at least one processor,
whereby execution of the program code by the at least one processor causes the wireless communication device to perform a method comprising:
using at least one light emitting diode, LED, as a transmitter, a wireless communication device sending outgoing optical wireless communication signals to a further wireless communication device;
using the at least one LED as a receiver, the wireless communication device receiving incoming optical wireless communication signals from the further wireless communication device; and
based on at least some of the received incoming optical wireless communication signals, the wireless communication device estimating a channel characteristic for the outgoing optical wireless communication signals.

18. A computer program product comprising a non-transitory computer readable medium storing a computer program comprising program code to be executed by at least one processor of a wireless communication device, whereby execution of the program code causes the wireless communication device to perform a method according to claim 1.
